(19) United States
(12) Patent Application Publication
(10) Pub. No.: US 2021/0329697 A1
(43) Pub. Date: Oct. 21, 2021

(54) METHOD FOR TRANSMITTING AND RECEIVING DATA AND ELECTRONIC DEVICE SUPPORTING THE SAME

(71) Applicant: Samsung Electronics Co., Ltd., Suwon-si (KR)

(72) Inventor: Dongwook LEE, Suwon-si (KR)

(21) Appl. No.: 17/230,568

(22) Filed: Apr. 14, 2021

(30) Foreign Application Priority Data
Apr. 16, 2020 (KR) 10-2020-0046204

(51) Int. Cl. H04W 74/08; H04W 74/00; H04W 52/02; H04W 4/80

(52) U.S. Cl. CPC H04W 74/0816; H04W 4/80; H04W 52/0216; H04W 74/008

(57) ABSTRACT

An electronic device is provided. The electronic device includes a first communication circuitry, a second communication circuitry, a processor, and a memory, wherein the processor is configured to connect a first external electronic device over a first channel of a designated frequency band, connect a second external electronic device over a second channel of the designated frequency band, determine a time when the second external electronic device transmits and receives data over the second channel, based on information on data transmission and reception of the second external electronic device, determine whether the first channel and the second channel overlap in part or are adjacent, and in response to determining that the first channel and the second channel overlap in part or are adjacent, transmit a signal requesting to limit use of the first channel over the first channel, before the determined time arrives.

### CROSS-REFERENCE TO RELATED APPLICATION(S)

This application is based on and claims priority under 35 U.S.C. § 119(a) of a Korean patent application number 10-2020-0046204, filed on Apr. 16, 2020, in the Korean Intellectual Property Office, the disclosure of which is incorporated by reference herein in its entirety.

### BACKGROUND

### 1. Field

The disclosure relates to a data transmission and reception technique. More particularly, the disclosure relates a device and a method for supporting data transmission and reception.

### 2. Description of Related Art

In recent, as communication technology of a network including internet rapidly advances, a data transmission and reception technology between devices over the network is rapidly developing. For example, a smart home system using internet of things (IoT) technology which transmits and receives data by connecting a plurality of things (IoT devices) over wired or wireless networks is under rapid development. In such a smart home system, IoT devices may transmit and receive data for state report or operation association of the IoT devices, and a user device and the IoT devices may transmit and receive data via an internet cloud for the sake of user's remote control.

Meanwhile, since devices using a designated frequency band among electronic devices which transmit and receive data through wireless communication operate independently, a congestion control method through scheduling in the data (e.g., packet) transmission and reception is used. For example, a wireless communication protocol wireless fidelity (Wi-Fi), Zigbee or Z-wave used by an access point (AP), a hub, a gateway, a station or a sensor device in the smart home system may transmit and receive data in an industrial scientific medical (ISM) band (e.g., 900 MHz, 2.4 GHz or 5.74 GHz). In so doing, any one device may exchange a request to send (RTS)/clear to send (CTS) signal before transmitting data using Wi-Fi, and thus prevent traffic occurred by data transmission of other devices.

A device which is activated (or wakes up) at specific intervals and transmits and receives data, such as a sensor device, needs to accomplish the RTS/CTS signal exchange and the data transmission and reception during the activation. However, if a communication channel in the designated frequency band is already used by other device, the communication channel may not be obtained (e.g., the channel is clear) within a short time and accordingly the device may not transmit and receive data during the activation. In this case, the device may repeat retry of the data transmission and reception several times during the activation, which increases battery consumption and shortens its lifetime.

Various embodiments of the disclosure may provide a data transmission and reception method and an electronic device supporting the same, for determining a data transmission and reception time of a device based on context information of devices using different protocols by sharing a designated frequency band, and restricting other external device from using a communication channel before the determined time arrives.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device supporting data transmission and reception.

Additional aspects will be set forth in part in the description which follows and, in part, will be apparent from the description, or may be learned by practice of the presented embodiments.

In accordance with an aspect of the disclosure, an electronic device is provided. The electronic device includes a first communication module, a second communication module, a processor operatively connected with the first communication module and the second communication module, and a memory operatively connected with the processor, wherein the processor may be configured to connect a first external electronic device over a first channel of a designated frequency band through the first communication module, connect a second external electronic device over a second channel of the designated frequency band through the second communication module, determine a data transmission and reception time of the second external electronic device over the second channel, based on data transmission and reception information of the second external electronic device, determine whether the first channel and the second channel overlap in part or are adjacent, and if determining that the first channel and the second channel overlap in part or are adjacent, transmit a signal requesting to limit use of the first channel over the first channel through the first communication module, before the determined time arrives.

In accordance with another aspect of the disclosure, an electronic device is provided. The electronic device includes a first communication module, a second communication module, a third communication module, a processor operatively connected with the first communication module, the second communication module and the third communication module, and a memory operatively connected with the processor, wherein the processor may be configured to connect a first external electronic device through the first communication module, obtain information of a first channel used by the first external electronic device in a designated frequency band, connect a second external electronic device over a second channel of the designated frequency band through the second communication module, determine a data transmission and reception time of the second external electronic device over the second channel, based on data transmission and reception information of the second external electronic device, determine whether the first channel and the second channel overlap in part or are adjacent, and if determining that the first channel and the second channel overlap in part or are adjacent, transmit a signal requesting to limit use of the first channel over the first channel through the third communication module, before the determined time arrives.

In accordance with another aspect of the disclosure, an electronic device is provided. The electronic device includes a first communication module, a second communication module, a third communication module, a processor operatively connected with the first communication module, the second communication module and the third communication module, and a memory operatively connected with the processor, wherein the processor may be configured to connect an external server through the first communication module, connect a first external electronic device over a first channel of a designated frequency band through the second communication module, obtain information of a second channel used by the first external electronic device in the designated frequency band, connect a second external electronic device over a third channel of the designated frequency band through the third communication module, determine a data transmission and reception time of the second external electronic device over the third channel, based on data transmission and reception information of the second external electronic device, determine whether the second channel and the third channel overlap in part or are adjacent, and if determining that the second channel and the third channel overlap in part or are adjacent, transmit a signal requesting to limit use of the second channel over the second channel through the second communication module, before the determined time arrives.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2A is a diagram for illustrating a method for transmitting and receiving data between devices which use a designated frequency band according to an embodiment of the disclosure;

FIG. 2B is a diagram for illustrating an electronic device of FIG. 2A according to an embodiment of the disclosure;

FIG. 3A is a diagram for illustrating another method for transmitting and receiving data between devices which use a designated frequency band according to an embodiment of the disclosure;

FIG. 3B is a diagram for illustrating an electronic device of FIG. 3A according to an embodiment of the disclosure;

FIG. 4A is a diagram for illustrating yet another method for transmitting and receiving data between devices which use a designated frequency band according to an embodiment of the disclosure;

FIG. 4B is a diagram for illustrating an electronic device of FIG. 4A according to an embodiment of the disclosure;

FIG. 5 is a diagram for illustrating a data transmission and reception method of a device which is activated at specific intervals according to an embodiment of the disclosure;

FIG. 6 is a diagram for illustrating an operating method of an electronic device according to an embodiment of the disclosure;

FIG. 7 is a diagram for illustrating another operating method of an electronic device according to an embodiment of the disclosure;

FIG. 8 is a diagram for illustrating yet another operating method of an electronic device according to an embodiment of the disclosure;

FIG. 9 is a diagram for illustrating a data transmission and reception method of an electronic device according to an embodiment of the disclosure; and

FIG. 10 is a diagram for illustrating another data transmission and reception method of an electronic device according to an embodiment of the disclosure.

Throughout the drawings, like reference numerals will be understood to refer to like parts, components and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

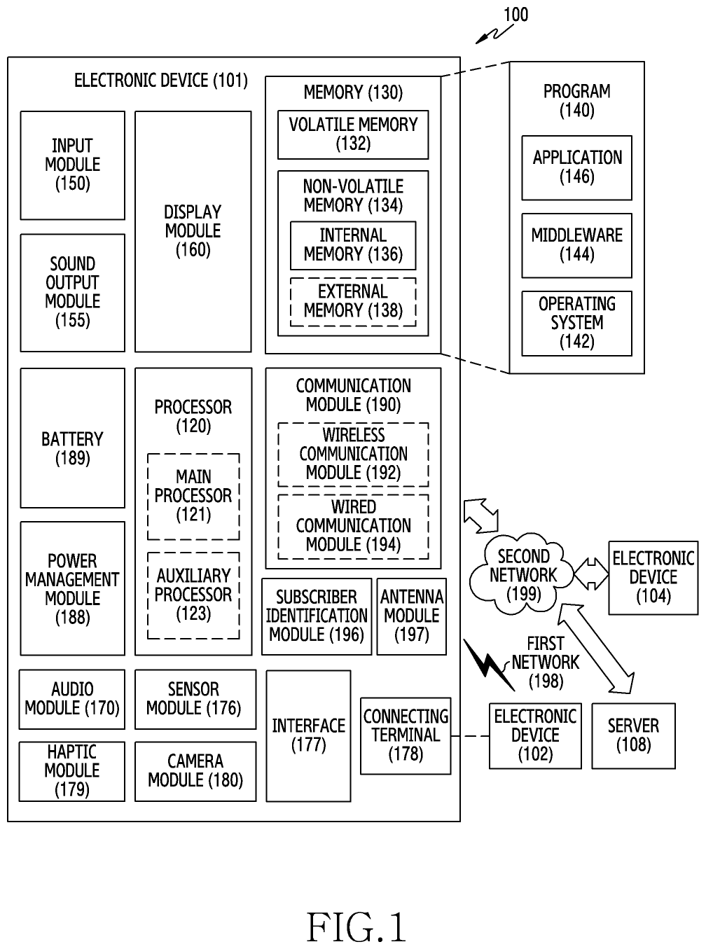

FIG. 1 is a block diagram illustrating an electronic device in a network environment according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture an image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

Devices which use a designated frequency band among electronic devices transmitting and receiving data through wireless communication may use a method for restricting other device from using a communication channel used for the data transmission and reception to prevent network congestion or data collision in the data (e.g., packet) transmission and reception. For example, if a device (or a node) for data transmission transmits a request to send (RTS) signal (or frame), a data (or a node) for receiving the data may respond with a clear to send (CTS) signal (or frame) and every other devices (nodes) receiving the RTS signal or the CTS signal may limit data transmission during a designated time. In so doing, time information for limiting the data transmission may be included in the RTS signal or the CTS signal.

However, a device using the designated frequency band may not obtain the communication channel for the data transmission and reception even if using the method which suggests such data transmission in a specific situation. For example, a device, such as a sensor, which is activated (or wakes up) at specific intervals and transmits and receives data may not acquire the communication channel due to the limited activation time even if the method for limiting the data transmission is used. Thus, the disclosure provides a data transmission and reception method for determining a data transmission and reception time of a device based on context information of a device using a designated frequency band, and restricting other external device from using a communication channel of the device before the determined time arrives.

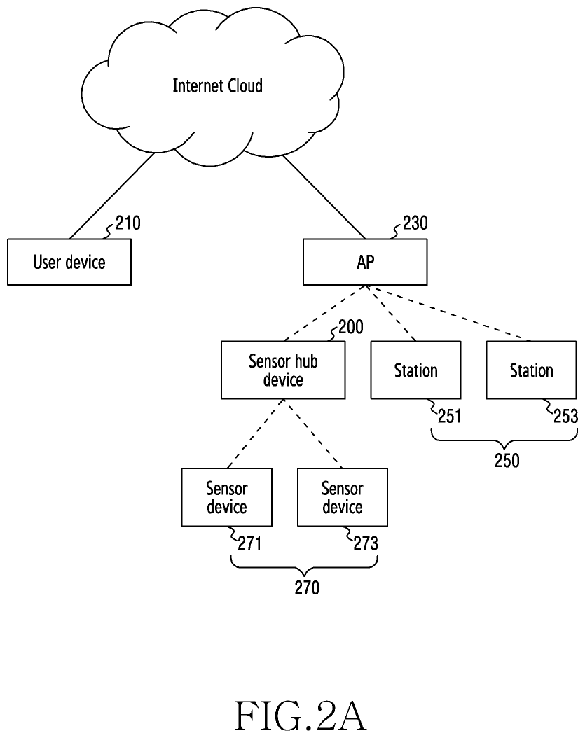

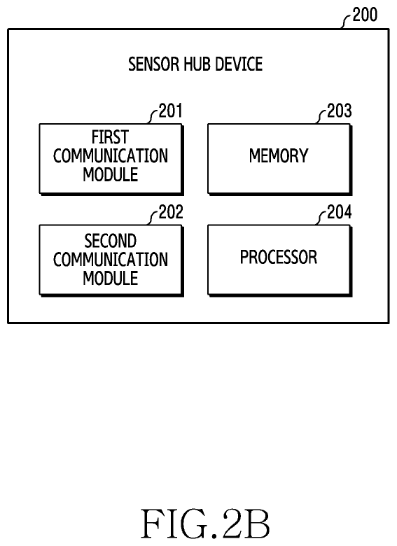

FIG. 2A is a diagram for illustrating a method for transmitting and receiving data between devices which use a designated frequency band according to an embodiment of the disclosure.

FIG. 2B is a diagram for illustrating an electronic device of FIG. 2A according to an embodiment of the disclosure.

Referring to FIGS. 2A and 2B, a user device 210 and a plurality of devices may transmit and receive data via an internet cloud. Herein, the plurality of the devices may include devices which use a designated frequency band in a specific space. For example, the plurality of the devices may include internet of things (IoT) devices in a smart home system. The plurality of the devices may include an access point (AP) 230, a device serving as a hub or a gateway (hereafter, referred to as a sensor hub device) 200, at least one station 250 (e.g., a first station 251 or a second station 253), and at least one sensor device 270 (e.g., a first sensor device 271 or a second sensor device 273).

According to an embodiment, the user device 210 may forward to the AP 230 a control signal (or data) related to user's remote control via the internet cloud, and the AP 230 may forward the received control signal to a remote control target device. For example, the AP 230 may forward the received control signal to any one station (e.g., the first station 251 or the second station 253), or may forward the received control signal to the sensor hub device 200 which connects the at least one sensor device 270 if the remote control target device is the sensor device. In this case, the sensor hub device 200 may forward the received control signal to any one sensor device (e.g., the first sensor device 271 or the second sensor device 273). According to another embodiment, the at least one sensor device 270 or the at least one station 250 may transmit a state signal (or data) to the user device 210 via the internet cloud for the sake of the state report of the device. For example, the at least one station 250 may forward the state signal to the AP 230, and the at least one sensor device 270 may forward the state signal to the AP 230 via the sensor hub device 200. The AP 230 may transmit the received state signal to the user device 210 via the internet cloud. According to yet another embodiment, the at least one sensor device 270 or the at least one station 250 may transmit and receive an operation signal (or data) between them for operation association. For example, the at least one station 250 may forward the operation signal to the at least one sensor device 270 via the AP 230 and the sensor hub device 200, and the at least one sensor device 270 may forward the operation signal to the at least one station 250 via the sensor hub device 200 and the AP 230.

The AP 230 may be connected to the internet cloud through wired and wireless communication, and may be connected with the at least one station 250 and the sensor hub device 200 through wireless communication. The AP 230 may be connected to the internet cloud through, for example, wired communication (e.g., Ethernet), and may be connected with the at least one station 250 and the sensor hub device 200 through wireless communication (e.g., Wi-Fi).

The sensor hub device 200 may include a first communication module 201, a second communication module 202, a memory 203 and a processor 204, as shown in FIG. 2B. The first communication module 201 may provide a wireless communication interface for connecting the sensor hub device 200 and the AP 230 in a designated frequency band. The first communication module 201 may support the same communication protocol as the communication protocol between the at least one station 250 and the AP 230. The second communication module 202 may provide a wireless communication interface for connecting the sensor hub device 200 and the at least one sensor device 270 in the designated frequency band. The designated frequency band used by the first communication module 201 and the second communication module 202 may include, for example, an ISM band (e.g., 900 MHz, 2.4 GHz or 5.7 GHz). The first communication module 201 and the second communication module 202 each may support, for example, at least one communication protocol of Wi-Fi, Zigbee, Z-wave, ultra wide band (UWB), Bluetooth low energy (BLE) mesh, or digital enhanced cordless telecommunications (DECT).

The memory 203 may store various data used by at least one component of the sensor hub device 200. According to an embodiment, the memory 203 may store context information of the at least one sensor device 270 connected through the second communication module 202. The context information may include, for example, at least one of activation/deactivation period (or wake-up/sleep period) information of the at least one sensor device 270, size information of a received command message (or control data), size information of a response message (or sensor data) for the command, period information for the state report or size information of a state report message (or data). The context information may be used to predict a data transmission and reception time of the at least one sensor device 270. The context information may be changed based on at least one of a user input or setting information stored in the at least one sensor device 270. For example, the size information of the command message in the context information may be updated based on size information of a command message newly received from an external electronic device (e.g., the user device 210 or the server 108 of FIG. 1).

The processor 204 may control at least one other component of the sensor hub device 200, and perform various data processing and calculations.

The processor 204 may connect the AP 230 through the first communication module 201 over a first channel of the designated frequency band. For example, the AP 230 may periodically transmit a beacon signal by selecting a specific channel of the designated frequency band, and the sensor hub device 200 may scan supported channels in the designated frequency band, and thus discover the AP 230 which is using the specific channel. In so doing, if a connection request with the AP 230 occurs, the processor 204 may connect the AP 230 which uses the specific channel, for example, a first channel through the first communication module 201.

According to an embodiment, the AP 230 may select a channel not to interfere with a channel of other AP in vicinity. If determining a problem in the selected channel, the AP 230 may change the selected channel. In so doing, the communication channel between the AP 230 and the sensor hub device 200 may be changed.

The processor 204 may connect the at least one sensor device 270 through the second communication module 202 over a second channel of the designated frequency band. For example, the at least one sensor device 270 may periodically transmit a beacon signal over a specific channel (e.g., the second channel) of the designated frequency band, and the sensor hub device 200 may scan the at least one sensor device 270. For example, the sensor hub device 200 may periodically transmit a beacon signal by selecting a specific channel (e.g., the second channel) of the designated frequency band, and the at least one sensor device 270 may scan supported channels in the designated frequency band, and thus discover the sensor hub device 200 which is using the specific channel.

According to an embodiment, the sensor hub device 200 may change the communication channel (e.g., the second channel) of the at least one sensor device 270. In so doing, the at least one sensor device 270 may not receive a response over the channel before changed, and accordingly may change the channel.

According to an embodiment, if the at least one sensor device 270 is connected, the sensor hub device 200 may determine a data transmission and reception time of the at least one sensor device 270 over the second channel, based on data transmission and reception information of the at least one sensor device 270. For example, the processor 204 may calculate the time based on the context information of the at least one sensor device 270 stored in the memory 203.

If determining (or calculating) the time, the processor 204 may determine whether the first channel and the second channel overlap, before the time arrives. In this regard, the first channel between the sensor hub device 200 and the AP 230 and the second channel between the sensor hub device 200 and the at least one sensor device 270 may partially overlap in the designated frequency band. For example, if the communication protocol between the sensor hub device 200 and the AP 230 is Wi-Fi communication protocol using a frequency bandwidth of about 20˜16 MHz in a frequency band of about 2.4 GHz, and the communication protocol between the sensor hub device 200 and the at least one sensor device 270 is Zigbee communication protocol using a frequency bandwidth of about 2 MHz in a frequency band of about 2400.0˜2483.5 GHz, the first channel and the second channel may overlap in part. If the first channel and the second channel do not overlap but the first channel and the second channel are close to each other, propagation interference may occur and accordingly the processor 204 may also determine their adjacency which may cause the propagation interference, in determining whether the channels overlap.

In various embodiments, determining the overlap or the propagation interference at the processor 204 may include determining (or identifying) an electronic device (e.g., an AP, a station, a node or a device) which transmits a signal in the Wi-Fi channel band overlapping the operation channel of the sensor device 270 and affecting its operation by causing interference to the operation channel of the sensor device 270.

If determining that the first channel and the second channel are overlapped (or adjacent), the processor 204 may restrict other external device (e.g., the AP 230 and the at least one station 250) than the at least one sensor device 270 from using a channel (an overlapping channel) overlapping (or adjacent to) the first channel and the second channel. For example, to clear the first channel which overlaps (or is adjacent to) the second channel, the processor 204 may transmit an RTS signal over the first channel through the first communication module 201. At this time, a destination of the RTS signal may be the sensor hub device 200, and the sensor hub device 200 which is the destination of the RTS signal may transmit a CTS signal based on the RTS signal over the first channel Other external devices receiving the RTS signal or the CTS signal may limit data transmission for a designated time. Hence, the first channel including the overlapping channel may be clear. If the first channel partially overlapping (or adjacent to) the second channel is clear, the processor 204, which transmits and receives data to and from the at least one sensor device 270 through the second communication module 202, may prevent data transmission and reception delay and collision. According to an embodiment, the first communication module 201 may support the Wi-Fi communication protocol, and the second communication module 202 may support at least one protocol of Zigbee or Z-wave.

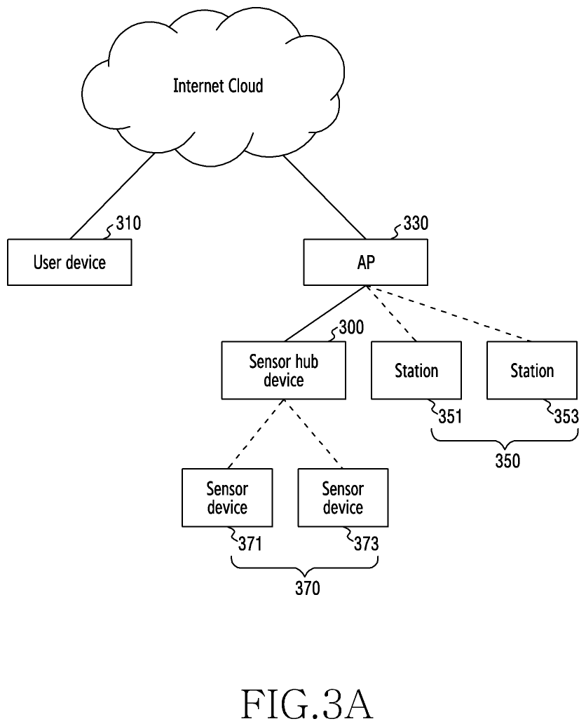

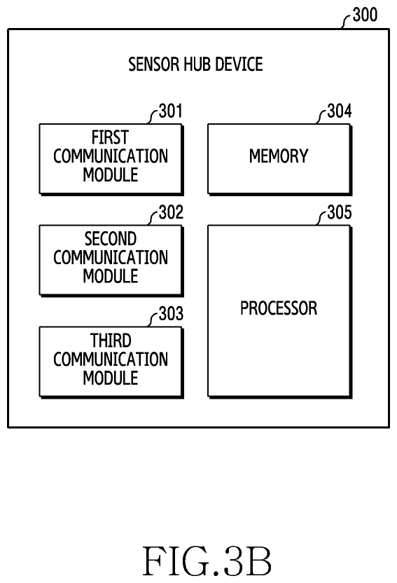

FIG. 3A is a diagram for illustrating another method for transmitting and receiving data between devices which use a designated frequency band according to an embodiment of the disclosure.

FIG. 3B is a diagram for illustrating an electronic device of FIG. 3A according to an embodiment of the disclosure.

FIGS. 3A and 3B illustrate a system structure in which a sensor hub device is connected with an AP through wired communication. In FIGS. 3A and 3B, descriptions on the similar configuration to FIGS. 2A and 2B shall be omitted.

Referring to FIGS. 3A and 3B, a user device 310 (e.g., the user device 210) and a plurality of devices may transmit and receive data through an internet cloud. Herein, the plurality of the devices may include devices which use a designated frequency band in a specific space, for example, IoT devices in a smart home system. The plurality of the devices may include an AP 330 (e.g., the AP 230), a sensor hub device 300 (e.g., the sensor hub device 200), at least one station 350 (e.g., a first station 351 or a second station 353) (e.g., the at least one station 250), and at least one sensor device 370 (e.g., a first sensor device 371 or a second sensor device 373) (e.g., the at least one sensor 270).

The AP 330 may be connected to the internet cloud through wired and wireless communication, connected to the at least one station 350 through wireless communication, and connected to the sensor hub device 300 through wired communication. The AP 330 may be connected with the internet cloud and the sensor hub device 300 through, for example, the wired communication (e.g., Ethernet), and connected with the at least one station 350 through the wireless communication (e.g., Wi-Fi).

The sensor hub device 300 may include a first communication module 301, a second communication module 302, a third communication module 303, a memory 304 and a processor 305, as shown in FIG. 3B. The first communication module 301 may provide a wireless communication interface for connecting the sensor hub device 300 and the AP 330. The second communication module 302 may provide a wireless communication interface for connecting the sensor hub device 300 and the at least one sensor device 370 in the designated frequency band. The third communication module 303 may provide a wireless communication interface for transmitting and receiving a signal (or data) in the designated frequency band. The third communication module 303 may support the same communication protocol as the communication protocol between the at least one station 350 and the AP 330. The designated frequency band used by the second communication module 302 and the third communication module 303 may include the ISM band. The second communication module 302 and the third communication module 303 each may support, for example, at least one communication protocol of Wi-Fi, Zigbee, Z-wave, UWB, BLE mesh, or DECT. In some embodiment, the first communication module 301 may provide a wireless communication interface for connecting the sensor hub device 300 and the AP 330 in the designated frequency band. In so doing, the wireless communication protocol supported by the first communication module 301 may be different from the wireless communication protocol supported by the third communication module 303. For example, the wireless communication protocol supported by the first communication module 301 may be the Wi-Fi communication protocol using the frequency band of about 5 GHz, and the wireless communication protocol supported by the third communication module 303 may be the Wi-Fi communication protocol using the frequency band of about 2.4 GHz.

The memory 304 may store various data used by at least one component of the sensor hub device 300. According to an embodiment, the memory 304 may store context information of the at least one sensor device 370 connected through the second communication module 302. The context information may include, for example, at least one of activation/deactivation period (or wake-up/sleep period) information of the at least one sensor device 370, size information of a received command message (or control data), size information of a response message (or sensor data) for the command, period information for the state report or size information of a state report message (or data). The context information may be used to predict a data transmission and reception time of the at least one sensor device 370. The context information may be changed based on at least one of a user input or setting information stored in the at least one sensor device 370. For example, the size information of the command message in the context information may be updated based on size information of a command message newly received.

The processor 305 may control at least one other component of the sensor hub device 300, and perform various data processing and calculations.

The sensor hub device 300 may connect the AP 330 through the first communication module 301. According to an embodiment, the sensor hub device 300 may connect the AP 330 by wire through the Ethernet communication protocol. According to another embodiment, the sensor hub device 300 may wirelessly connect the AP 330 through the Wi-Fi communication protocol. A frequency band used to connect the sensor hub device 300 and the AP 330 may be different from a frequency band used to connect the AP 330 and the at least one station 350. For example, the wireless communication protocol between the sensor hub device 300 and the AP 330 may be the Wi-Fi communication protocol using the frequency band of about 5 GHz, and the wireless communication protocol between the AP 330 and the at least one station 350 may be the Wi-Fi communication protocol using the frequency band of about 2.4 GHz.

If the AP 330 is connected, the processor 305 may obtain first channel information used by the AP 330 in the designated frequency band to connect the at least one station 350.

The sensor hub device 200 may connect the at least one sensor device 370 over a second channel of the designated frequency band through the second communication module 302. If the at least one sensor device 370 is connected, the processor 305 may determine a data transmission and reception time of the at least one sensor device 370 over the second channel, based on data transmission and reception information of the at least one sensor device 370. For example, the processor 305 may calculate the time based on context information of the at least one sensor device 370 stored in the memory 304.

If determining (or calculating) the time, the processor 305 may determine whether the first channel and the second channel overlap, before the time arrives. For example, the processor 305 may determine whether the first channel between the AP 330 and the at least one station 350 and the second channel between the sensor hub device 300 and the at least one sensor device 370 partially overlap in the designated frequency band or are adjacent to cause the propagation interference.

If determining that the first channel and the second channel are overlapped (or adjacent), the processor 305 may restrict other external device (e.g., the AP 330 and the at least one station 350) than the at least one sensor device 370 from using a channel (an overlapping channel) overlapping (or adjacent to) the first channel and the second channel. For example, to clear the first channel overlapping (or adjacent to) the second channel, the processor 305 may set a communication channel of the third communication module 303 to the first channel, and transmit an RTS signal over the first channel through the third communication module 303. At this time, a destination of the RTS signal may be the sensor hub device 300, and the sensor hub device 300 which is the destination of the RTS signal may transmit a CTS signal based on the RTS signal over the first channel Other external devices receiving the RTS signal or the CTS signal may limit data transmission for a designated time. Hence, the first channel including the overlapping channel may be clear.

If the first channel partially overlapping (or adjacent to) the second channel is clear, the processor 305 which transmits and receives data to and from the at least one sensor device 370 through the second communication module 302 may prevent data transmission and reception delay and collision.

According to an embodiment, the first communication module 301 may support the Ethernet communication protocol, the second communication module 302 may support at least one communication protocol of Zigbee or Z-wave, and the third communication module 303 may support the Wi-Fi communication protocol.

According to another embodiment, the first communication module 301 may support the Wi-Fi communication protocol using the frequency band of about 5 GHz, the second communication module 302 may support at least one communication protocol of Zigbee or Z-wave, and the third communication module 303 may support the Wi-Fi communication protocol using the frequency band of about 2.4 GHz.

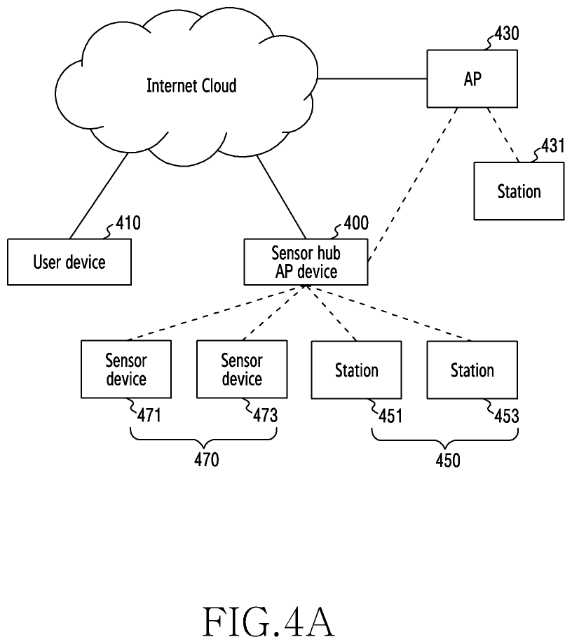

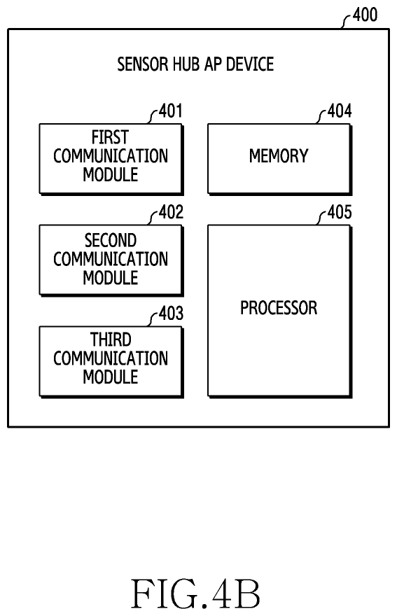

FIG. 4A is a diagram for illustrating yet another method for transmitting and receiving data between devices which use a designated frequency band according to an embodiment of the disclosure.

FIG. 4B is a diagram for illustrating an electronic device of FIG. 4A according to an embodiment of the disclosure.

FIGS. 4A and 4B illustrate a system structure in which a sensor hub device also serves as an AP. In FIGS. 4A and 4B, descriptions on the similar configuration to FIG. 2A through FIG. 3B shall be omitted.

Referring to FIGS. 4A and 4B, a user device 410 (e.g., the user device 210 or the user device 310) and a plurality of devices may transmit and receive data through an internet cloud. Herein, the plurality of the devices may include devices which use a designated frequency band in a specific space and devices using the designated frequency band in a different space from the specific space. The plurality of the devices may include a first AP 430 (e.g., the AP 230 or the AP 330), at least one station 431 (e.g., the at least one station 250 or the at least one station 350) connected to the first AP 430, a device serving as a hub or a gateway and a second AP (hereafter, referred to as a sensor hub AP device) 400, at least one station 450 (e.g., a first station 451 or a second station 453) connected to the sensor hub AP device 400 and at least one sensor device 470 (e.g., a first sensor device 471 or a second sensor device 473) (e.g., the at least one sensor 270 or the at least one sensor device 370).

The first AP 430 may be connected to the internet cloud through wired and wireless communication, and connected to the at least one station 431 and the sensor hub AP device 400 through wireless communication. For example, the first AP 430 may be connected to the internet cloud through the wired communication (e.g., Ethernet), and to the at least one station 431 and the sensor hub AP device 400 through the wireless communication (e.g., Wi-Fi).

The sensor hub AP device 400 may include a first communication module 401, a second communication module 402, a third communication module 403, a memory 404 and a processor 405, as shown in FIG. 4B. The first communication module 401 may provide a wired and wireless communication interface for connecting the sensor hub AP device 400 to the internet cloud. The second communication module 402 may provide a wireless communication interface for the connection between the sensor hub AP device 400 and the first AP 430 in the designated frequency band and the connection between the sensor hub AP device 400 and the at least one station 450 in the designated frequency band. The third communication module 403 may provide a wireless communication interface for connecting the sensor hub AP device 400 and the at least one sensor device 470 over the designated frequency band. The designated frequency band used by the second communication module 402 and the third communication module 403 may include the ISM band. The second communication module 402 and the third communication module 403 each may support, for example, at least one communication protocol of Wi-Fi, Zigbee, Z-wave, UWB, BLE mesh, or DECT.

The memory 404 may store various data used by at least one component of the sensor hub AP device 400. According to an embodiment, the memory 404 may store context information of the at least one sensor device 470 connected through the third communication module 403. The context information may include, for example, at least one of activation/deactivation period (or wake-up/sleep period) information of the at least one sensor device 470, size information of a received command message (or control data), size information of a response message (or sensor data) for the command, period information for the state report or size information of a state report message (or data). The context information may be used to predict a data transmission and reception time of the at least one sensor device 470. The context information may be changed based on at least one of a user input or setting information stored in the at least one sensor device 470. For example, the size information of the command message in the context information may be updated based on size information of a command message newly received.

The processor 405 may control at least one other component of the sensor hub AP device 400, and perform various data processing and calculations.

The sensor hub AP device 400 may connect the internet cloud through the first communication module 401. According to an embodiment, the sensor hub AP device 400 may connect the first AP 430 and the at least one station 450 over a first channel of the designated frequency band through the second communication module 402. If the first AP 430 is connected, the processor 405 may obtain second channel information used by the first AP 430 in the designated frequency band to connect the at least one station 431.

The sensor hub AP device 400 may connect the at least one sensor device 470 over a third channel of the designated frequency band through the third communication module 403. If the at least one sensor device 470 is connected, the processor 405 may determine a data transmission and reception time of the at least one sensor device 470 over the third channel, based on data transmission and reception information of the at least one sensor device 470. For example, the processor 405 may calculate the time based on context information of the at least one sensor device 470 stored in the memory 404.

If determining (or calculating) the time, the processor 405 may determine whether the second channel and the third channel overlap, before the time arrives. For example, the processor 405 may determine whether the second channel between the first AP 430 and the at least one station 431 and the third channel between the sensor hub AP device 400 and the at least one sensor device 470 partially overlap in the designated frequency band or are adjacent to cause the propagation interference. In some embodiment, the processor 405 may further determine whether the first channel and the third channel overlap. For example, the processor 405 may determine whether the first channel between the sensor hub AP device 400 and the at least one station 450 and the third channel between the sensor hub AP device 400 and the at least one sensor device 470 partially overlap in the designated frequency band or are adjacent to cause the propagation interference.

If determining that the second channel and the third channel are overlapped (or adjacent), the processor 405 may restrict other external device (e.g., the first AP 430 and the at least one station 431 connected with the first AP 430) than the at least one sensor device 470 from using a channel (an overlapping channel) overlapping (or adjacent to) the second channel and the third channel. For example, the processor 405 may change the communication channel of the second communication module 402 to the second channel, and transmit an RTS signal through the second communication module 402 over the second channel. At this time, a destination of the RTS signal may be the sensor hub AP device 400, and the sensor hub AP device 400 which is the destination of the RTS signal may transmit a CTS signal based on the RTS signal over the second channel Other external devices receiving the RTS signal or the CTS signal may limit data transmission for a designated time. Hence, the second channel including the overlapping channel may be clear. Next, the processor 405 may change (or restore) the communication channel of the second communication module 402 changed to the second channel, to the first channel before changing.

If the second channel partially overlapping (or adjacent to) the third channel is clear, the processor 405 which transmits and receives data to and from the at least one sensor device 470 through the third communication module 403, may prevent data transmission and reception delay and collision.

If determining that the first channel and the third channel are overlapped (or adjacent), the processor 405 may restrict other external device (e.g., the first AP 430, the sensor hub AP device 400 and the at least one station 450 connected with the sensor hub AP device 400) than the at least one sensor device 470 from using a channel (an overlapping channel) overlapping (or adjacent to) the first channel and the third channel. For example, the processor 405 may transmit an RTS signal through the second communication module 402 over the first channel. At this time, a destination of the RTS signal may be the sensor hub AP device 400, and the sensor hub AP device 400 which is the destination of the RTS signal may transmit a CTS signal based on the RTS signal over the first channel Other external devices receiving the RTS signal or the CTS signal may limit data transmission for a designated time. Hence, the first channel including the overlapping channel may be clear. If the first channel partially overlapping (or adjacent to) the third channel is clear, the processor 405 which transmits and receives data to and from the at least one sensor device 470 through the third communication module 403, may prevent data transmission and reception delay and collision.

According to an embodiment, the first communication module 401 may support the Ethernet communication protocol, the second communication module 402 may support the Wi-Fi communication protocol, and the third communication module 403 may support at least one communication protocol of Zigbee or Z-wave.

According to an embodiment, by temporarily resetting and transmitting a traffic indication map (TIM) field in a beacon message together with the RTS signal, the processor 405, the processor 405 may notify the other external device of no transmit packet and thus control not to wake up the other external device from the sleep state (or the inactive state).

As stated above, according to various embodiments, an electronic device (e.g., the sensor hub device 200) may include a first communication module (e.g., the first communication module 201), a second communication module (e.g., the second communication module 202), a processor (e.g., the processor 204) operatively connected with the first communication module and the second communication module, and a memory (e.g., the memory 203) operatively connected with the processor, and the processor may be configured to connect a first external electronic device (e.g., the AP 230) over a first channel of a designated frequency band through the first communication module, connect a second external electronic device (e.g., the at least one sensor device 270) over a second channel of the designated frequency band through the second communication module, determine a time when the second external electronic device transmits and receives data over the second channel, based on information on data transmission and reception of the second external electronic device, determine whether the first channel and the second channel overlap in part or are adjacent, and if determining that the first channel and the second channel overlap in part or are adjacent, transmit a signal requesting to limit use of the first channel over the first channel through the first communication module, before the determined time arrives.

According to various embodiments, the signal requesting to limit the use of the first channel may include an RTS signal, and the RTS signal may include information of the determined time.

According to various embodiments, the processor may be configured to transmit a CTS signal based on the RTS signal through the first communication module, and the CTS signal may include information of the determined time.

According to various embodiments, the memory may store the information on data transmission and reception of the second external electronic device, and the information on data transmission and reception of the second external electronic device may include at least one of activation/deactivation period information of the second external electronic device, size information of a command message transmitted to the second external electronic device, size information of a response message for the command message, period information for reporting state of the second external electronic device, or size information of a report message of the state of the second external electronic device.

According to various embodiments, the designated frequency band may include an ISM band, and the first communication module and the second communication each may support at least one communication protocol of Wi-Fi, Zigbee, Z-wave, UWB, BLE mesh, or DECT.

As stated above, according to various embodiments, an electronic device (e.g., the sensor hub device 300) may include a first communication module (e.g., the first communication module 301), a second communication module (e.g., the second communication module 302), a third communication module (e.g., the third communication module 303), a processor (e.g., the processor 305) operatively connected with the first communication module, the second communication module and the third communication module, and a memory (e.g., the memory 304) operatively connected with the processor, and the processor may be configured to connect a first external electronic device (e.g., the AP 330) through the first communication module, obtain information of a first channel used by the first external electronic device in a designated frequency band, connect a second external electronic device (e.g., the at least one sensor device 370) over a second channel of the designated frequency band through the second communication module, determine a time when the second external electronic device transmits and receives data over the second channel, based on information of data transmission and reception of the second external electronic device, determine whether the first channel and the second channel overlap in part or are adjacent, and if determining that the first channel and the second channel overlap in part or are adjacent, transmit a signal requesting to limit use of the first channel over the first channel through the third communication module, before the determined time arrives.

According to various embodiments, the processor may connect the first external electronic device in wireless communication through the first communication module, and a frequency band used to connect the first external electronic device may be different from a frequency band used by the first external electronic device to connect other external electronic device (e.g., the at least one station 350).

According to various embodiments, the signal requesting to limit the use of the first channel may include an RTS signal, and the RTS signal may include information of the determined time.

According to various embodiments, the processor may be configured to transmit a CTS signal based on the RTS signal through the third communication module, and the CTS signal may include information of the determined time.

According to various embodiments, the memory may store the information on data transmission and reception of the second external electronic device, and the information on data transmission and reception of the second external electronic device may include at least one of activation/deactivation period information of the second external electronic device, size information of a command message transmitted to the second external electronic device, size information of a response message for the command message, period information for reporting state of the second external electronic device, or size information of a report message of the state of the second external electronic device.

According to various embodiments, the designated frequency band may include an ISM band, and the second communication module and the third communication each may support at least one communication protocol of Wi-Fi, Zigbee, Z-wave, UWB, BLE mesh, or DECT.

As stated above, according to various embodiments, an electronic device (e.g., the sensor hub AP device 400) may include a first communication module (e.g., the first communication module 401), a second communication module (e.g., the second communication module 402), a third communication module (e.g., the third communication module 403), a processor (e.g., the processor 405) operatively connected with the first communication module, the second communication module and the third communication module, and a memory (e.g., the memory 404) operatively connected with the processor, and the processor may be configured to connect an external server (e.g., the internet cloud) through the first communication module, connect a first external electronic device (e.g., the first AP 430) over a first channel of a designated frequency band through the second communication module, obtain information of a second channel used by the first external electronic device in the designated frequency band, connect a second external electronic device (e.g., the at least one sensor device 470) over a third channel of the designated frequency band through the third communication module, determine a time when the second external electronic device transmits and receives data over the third channel, based on information on data transmission and reception of the second external electronic device, determine whether the second channel and the third channel overlap in part or are adjacent, and if determining that the second channel and the third channel overlap in part or are adjacent, transmit a signal requesting to limit use of the second channel over the second channel through the second communication module, before the determined time arrives.

According to various embodiments, the processor may be configured to change a communication channel of the second communication module to the second channel, and transmit an RTS signal over the second channel, and the RTS signal may include information of the determined time.

According to various embodiments, the processor may be configured to transmit a CTS signal based on the RTS signal through the second communication module, and the CTS signal may include information of the determined time.

According to various embodiments, the processor may be configured to restore the communication channel of the second communication module to the first channel.

According to various embodiments, the processor may be configured to reset a TIM field in a beacon message, and transmit the beacon message together with the RTS signal.

According to various embodiments, the processor may be configured to determine whether the first channel and the third channel overlap in part or are adjacent, and if determining that the first channel and the third channel overlap in part or are adjacent, transmit a signal requesting to limit use of the first channel over the first channel through the second communication module, before the determined time arrives.

According to various embodiments, the signal requesting to limit the use of the first channel may include at least one of an RTS signal or a CTS signal.

According to various embodiments, the memory may store the information on data transmission and reception of the second external electronic device, and the information on data transmission and reception of the second external electronic device may include at least one of activation/deactivation period information of the second external electronic device, size information of a command message transmitted to the second external electronic device, size information of a response message for the command message, period information for reporting state of the second external electronic device, or size information of a report message of the state of the second external electronic device.

According to various embodiments, the designated frequency band may include an ISM band, and the second communication module and the third communication each may support at least one communication protocol of Wi-Fi, Zigbee, Z-wave, UWB, BLE mesh, or DECT.

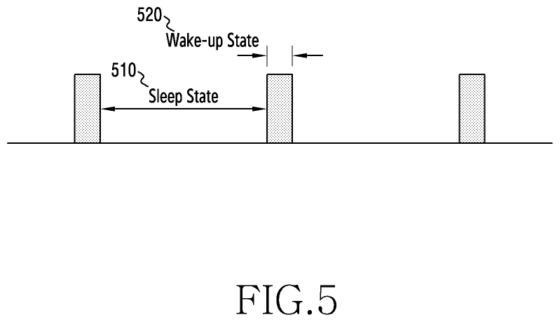

FIG. 5 is a diagram for illustrating a data transmission and reception method of a device activated at specific intervals according to an embodiment of the disclosure.

Referring to FIG. 5, according to an embodiment, a first device (e.g., the sensor device 270, 370 or 470) having no communication interface to access the internet may need a second device (e.g., the sensor hub device 200 or 300 or the sensor hub AP device 400) serving as a hub or a gateway to transmit and receive data to and from a user device via the internet cloud. The first device may be connected to the second device over the designated frequency band, and the second device may prevent data transmission and reception delay and collision of the first device due to data transmission and reception of other external device using the designated frequency band.

In an embodiment, the second device may determine a data transmission and reception time of the first device based on context information of the first device, and restrict other external device from using a communication channel of the first device before the determined time arrives. For example, the second device may determine whether the communication channel (e.g., the first channel) of the first device and a communication channel of the other external device overlap or are adjacent to cause propagation interference, and if determining that the first channel and the second channel are overlapped (or adjacent), restrict the other external device from using the second channel by transmitting an RTS signal over the second channel before the data transmission and reception time of the first device arrives. Hence, the second channel including the overlapping channel is clear, and the first device may transmit and receive data over the first channel without delay and collision.

The context information may include, for example, at least one of activation/deactivation period (or wake-up/sleep period) information of the first device, size information of a received command message (or control data), size information of a response message (or sensor data) for the command, period information for the state report or size information of a state report message (or data). The context information may be used to predict the data transmission and reception time of the first device. For example, the second device may determine a time for transmitting the RTS and a time for obtaining the time through the RTS based on time information (e.g., the activation/deactivation or state report period) for operating the second device, a size of a message (e.g., a command message) transmitted from the second device to the first device and a size of a message (e.g., a response message or a state report message) transmitted from the first device to the second device. For example, the second device may determine the time for transmitting the RTS and the time for obtaining the time through the RTS based on the number of external electronic devices which use the second channel overlapping the first channel or causing the propagation interference.

FIG. 5 shows the activation/deactivation period of the first device contained in the context information. The first device may enter from a sleep state 510 (or the deactivation state) to a wake-up state 520 (or the activation state) at specific intervals, and broadcast a wake-up message. The second device receiving the wake-up message may transmit data destined for the first device. For example, the first device which is to transmit the wake-up message may not obtain a communication channel due to data transmission and reception of other external device. For example, the wake-up message transmitted by the first device may interfere with data transmitted by other external device. If the data transmitted by the first device is not transmitted to the second device, the first device may abandon the transmission or try retransmission according to a policy. In this case, the data is not transmitted and received at an intended time, and several retransmissions repeated may increase battery consumption of the first device and shorten the lifetime.

To prevent this, in forwarding a command (or a control signal) message received from the internet cloud to the first device, the second device may calculate the time for obtaining the communication channel, based on a time of the wake-up state 520 (or the activation state) of the first device, a message size of the received command and a size of a response message for the received command, and transmit an RTS signal (and a CTS signal) over the second channel (e.g., the communication channel of the other external device) by setting the calculated time. Next, the first device may enter the wake-up state 520 (or the activation state) as scheduled and transmit the wake-up message, and the second device receiving the wake-message may transmit the command message to the first device. The first device receiving the command message may generate and transmit to the second device the response message corresponding to the command. In so doing, the communication channel between the second device and the other external device (e.g., the communication channel at least in part overlapping or causing interference to the communication channel used by the first device) may remain clear.

According to an embodiment, the first period may periodically perform the state report to the internet cloud (or the user device). For example, the first device may transmit its acquired information to the internet cloud at specific intervals. Period information of the state report of the first device and size information of the state report message may be stored and managed in context information of the first device. The second device may calculate a time for obtaining the communication channel for the first device's state report, based on the period information of the state report of the first device and the size information of the state report message, and transmit an RTS signal (and a CTS signal) over the second channel (e.g., the communication channel with the other external device) before the first device transmits the state report message by setting the calculated time. Next, the first device may enter the wake-up state 520 (or the activation state) as scheduled and transmit the wake-up message, and the second device receiving the state report message may transmit a response message (e.g., an acknowledge (ACK) signal) for the state report message to the first device and transmit the received state report message to the internet cloud. In so doing, the communication channel between the second device and the other external device (e.g., the communication channel at least in part overlapping or causing interference to the communication channel of the first device) may remain clear.

According to an embodiment, the first device may transmit and receive a plurality of data in succession to and from the internet cloud (or the user device). For example, a plurality of packets may be exchanged in succession, in registering the first device at the smart home system. The number of the packets may vary according to a wireless communication protocol (e.g., Zigbee or Z-wave) supported by the first device, and may differ depending on a type of the first device. If the successive packet exchanges are predicted, the second device may transmit a plurality of RTS signals (and CTS signals) over the second channel. For example, if the second channel is clear with one RTS signal (or CTS signal) and the plurality of the packet exchanges is not finished, the second device may additionally acquire the clear state of the second channel by transmitting another RTS signal (or CTS signal) in succession. According to an embodiment, an available time for maintaining the clear state of the communication channel with one RTS signal (or CTS signal) may be about 32.767 ms.

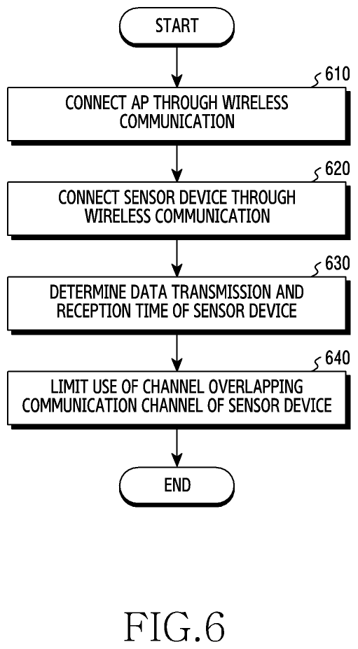

FIG. 6 is a diagram for illustrating an operating method of an electronic device according to an embodiment of the disclosure.

Referring to FIG. 6, a processor (e.g., the processor 204) of an electronic device (e.g., the sensor hub device 200 of FIGS. 2A and 2B) may connect an AP (e.g., the AP 230) through wireless communication, in operation 610. For example, the processor may connect the AP over a first channel of a designated frequency band through a first communication module (e.g., the first communication module 201). According to an embodiment, the designated frequency band may include the ISM band (e.g., 900 MHz, 2.4 GHz or 5.7 GHz).

In operation 620, the processor may wirelessly connect at least one sensor device 270 (e.g., the first sensor device 271 or the second sensor device 273). For example, the processor may connect the at least one sensor device over a second channel of the designated frequency band through a second communication module (e.g., the second communication module 202).

According to an embodiment, the first communication module and the second communication module each may support at least one communication protocol of Wi-F, Zigbee, Z-wave, UWB, BLE mech, or DECT. For example, the first communication module may support the Wi-Fi communication module, and the second communication module may support at least one communication protocol of Zigbee or Z-wave.

In operation 630, the processor may determine a data transmission and reception time of the at least one sensor device. Based on data transmission and reception information of the at least one sensor device, the processor may determine the data transmission and reception time of the at least one sensor device over the second channel. For example, the processor may calculate the time based on context information of the at least one sensor device stored in a memory (e.g., the memory 203). The context information may include, for example, at least one of activation/deactivation period (or wake-up/sleep period) information of the at least one sensor device, size information of a received command message (or control data), size information of a response message (or sensor data) for the command, period information for the state report or size information of a state report message (or data).

In operation 640, the processor may limit use of a channel overlapping (or adjacent to cause propagation interference) the communication channel of the at least one sensor device. If determining (or calculating) the time, the processor may determine whether the first channel and the second channel overlap, before the determined (or calculated) time arrives. For example, if the electronic device is connected to the at least one sensor device and then connected to the AP, the first channel and the second channel may overlap in part or may be adjacent to cause the propagation interference. Even if the electronic device is connected to the AP and then connected to the at least one sensor device but the communication channel (the second channel) of the at least one sensor device is fixed, the first channel and the second channel may overlap in part or may be adjacent to cause the propagation interference. If determining that the first channel and the second channel overlap (or are adjacent), the processor may restrict other external device (e.g., the AP and the at least one station) than the at least one sensor device from using the channel (the overlapping channel) overlapping (or adjacent to) the first channel and the second channel.

According to an embodiment, to clear the first channel overlapping (or adjacent to) the second channel, the processor may transmit an RTS signal over the first channel through the first communication module. At this time, a destination of the RTS signal may be the electronic device, and the electronic device which is the destination of the RTS signal may transmit a CTS signal based on the RTS signal over the first channel Other external devices receiving the RTS signal or the CTS signal may limit data transmission for a designated time. Hence, the first channel including the overlapping channel may be clear.

If the first channel partially overlapping (or adjacent to) the second channel is clear, the processor, which transmits and receives data to and from the at least one sensor device through the second communication module, may prevent data transmission and reception delay and collision.

According to various embodiments, the electronic device may monitor the communication channel being used through the first communication module, and prevent data transmission and reception delay and collision with the at least one sensor device based on a monitoring result. In an embodiment, if determining that the first channel and the second channel do not partially overlap or are not adjacent, the processor may identify whether there is a third channel which may affect the second channel (e.g., partially overlapping or adjacent to the second channel). For example, the processor may monitor a signal of the third channel which may affect the second channel on a periodic basis or for a specific time through the first communication module. According to an embodiment, if determining the third channel which may affect the second channel based on the monitoring result, the processor may transmit an RTS signal requesting the use limit of the third channel through the first communication module in operation 640. For example, the processor may determine the data transmission and reception time of the at least one sensor device, transmit the RTS signal by changing the communication channel of the first communication module to the third channel, and then control to change the communication channel of the first communication module to the first channel.

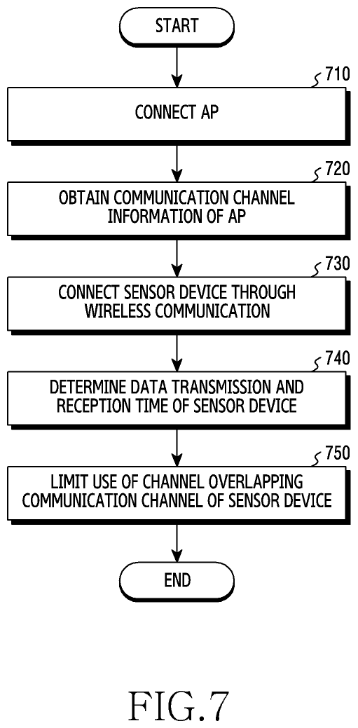

FIG. 7 is a diagram for illustrating another operating method of an electronic device according to an embodiment of the disclosure.

Referring to FIG. 7, a processor (e.g., the processor 305) of an electronic device (e.g., the sensor hub device 300 of FIGS. 3A and 3B) may connect an AP (e.g., the AP 330), in operation 710. For example, the processor may connect the AP through a first communication module (e.g., the first communication module 301). According to an embodiment, the processor may connect the AP in wired communication through the first communication module. For example, the first communication module may support the Ethernet communication protocol. According to another embodiment, the processor may connect the AP in wireless communication through the first communication module. For example, the first communication module may support the Wi-Fi communication protocol.

In operation 720, the processor may obtain communication channel information of the AP. For example, the processor may obtain first channel information used by the AP in the designated frequency band to connect the at least one station 350 (e.g., the first station 351 or the second station 353). According to an embodiment, the designated frequency band may include the ISM band (e.g., 900 MHz, 2.4 GHz or 537 GHz).

If the electronic device is connected with the AP in the wireless communication, a frequency band used to connect the electronic device and the AP may be different from a frequency band used to connect the AP and the at least one station. For example, the wireless communication protocol between the electronic device and the AP may be the Wi-Fi communication protocol using the frequency band of about 5 GHz, and the wireless communication protocol between the AP and the at least one station may be the Wi-Fi communication protocol using the frequency band of about 2.4 GHz.

In operation 730, the processor may connect at least one sensor device 370 (e.g., the first sensor device 371 or the second sensor device 373) in wireless communication. For example, the processor may connect the at least one sensor device over a second channel of the designated frequency band through a second communication module (e.g., the second communication module 302).

In operation 740, the processor may determine a data transmission and reception time of the at least one sensor device. Based on data transmission and reception information of the at least one sensor device, the processor may determine the data transmission and reception time of the at least one sensor device over the second channel. For example, the processor may calculate the time based on context information of the at least one sensor device stored in a memory (e.g., the memory 304). The context information may include, for example, at least one of activation/deactivation period (or wake-up/sleep period) information of the at least one sensor device, size information of a received command message (or control data), size information of a response message (or sensor data) for the command, period information for the state report or size information of a state report message (or data).

In operation 750, the processor may limit use of a channel overlapping (or adjacent to cause propagation interference) the communication channel of the at least one sensor device. If determining (or calculating) the time, the processor may determine whether the first channel and the second channel overlap, before the determined (or calculated) time arrives. If determining that the first channel and the second channel overlap (or are adjacent), the processor may restrict other external device (e.g., the AP and the at least one station) than the at least one sensor device from using the channel (the overlapping channel) overlapping (or adjacent to) the first channel and the second channel.

According to an embodiment, to clear the first channel overlapping (or adjacent to) the second channel, the processor may set a communication channel of a third communication module (e.g., the third communication module 303) to the first channel, and transmit an RTS signal to the first channel through the third communication module. At this time, a destination of the RTS signal may be the electronic device, and the electronic device which is the destination of the RTS signal may transmit a CTS signal based on the RTS signal over the first channel Other external devices receiving the RTS signal or the CTS signal may limit data transmission for a designated time. Hence, the first channel including the overlapping channel may be clear.

If the first channel partially overlapping (or adjacent to) the second channel is clear, the processor, which transmits and receives data to and from the at least one sensor device through the second communication module, may prevent data transmission and reception delay and collision.

According to an embodiment, the second communication module and the third communication module each may support at least one communication protocol of Wi-F, Zigbee, Z-wave, UWB, BLE mech, or DECT. For example, the second communication module may support at least one communication protocol of Zigbee or Z-wave, and the third communication module may support the Wi-Fi communication protocol.

According to various embodiments, the electronic device may monitor the communication channel being used through the third communication module, and prevent data transmission and reception delay and collision with the at least one sensor device based on a monitoring result. In an embodiment, if determining that the first channel and the second channel do not partially overlap or are not adjacent, the processor may identify whether there is a third channel which may affect the second channel (e.g., partially overlapping or adjacent to the second channel). For example, the processor may monitor a signal of the third channel which may affect the second channel on a periodic basis or for a specific time through the third communication module. According to an embodiment, if determining the third channel which may affect the second channel based on the monitoring result, the processor may transmit an RTS signal requesting the use limit of the third channel through the third communication module in operation 750. For example, the processor may determine the data transmission and reception time of the at least one sensor device, transmit the RTS signal by changing the communication channel of the third communication module to the third channel, and then clear the third channel.

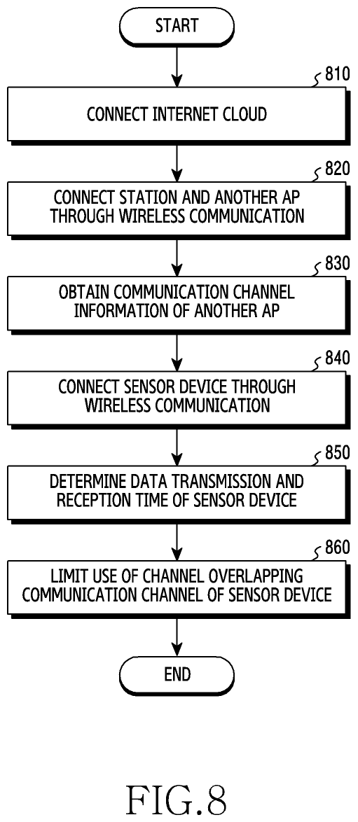

FIG. 8 is a diagram for illustrating yet another operating method of an electronic device according to an embodiment of the disclosure.

Referring to FIG. 8, an electronic device (e.g., the sensor hub AP device 400 of FIGS. 4A and 4B) may serve as a hub or a gateway and an AP. For doing so, a processor (e.g., the processor 405) of the electronic device may connect an internet cloud (e.g., an external server) through a first communication module (e.g., the first communication module 401), in operation 810. According to an embodiment, the first communication module may support the Ethernet communication protocol.

In operation 820, the processor may connect at least one station (e.g., the first station 451 or the second station 453) and another AP (e.g., the first AP 430) through wireless communication. For example, the processor may connect the at least one station and the another AP over a first channel of a designated frequency band through a second communication module (e.g., the second communication module 402). According to an embodiment, the designated frequency band may include the ISM band (e.g., 900 MHz, 2.4 GHz or 5.7 GHz).

In operation 830, the processor may obtain communication channel information of the another AP. For example, the processor may obtain second channel information used by the another AP in the designated frequency band to connect the at least one other station (e.g., the at least one station 431). According to an embodiment, the processor may obtain channel change information of the another AP, and obtain the second channel information based on the channel change information. According to another embodiment, the processor may acquire the information of the second channel used by the another AP, through channel scanning through the second communication module.

In operation 840, the processor may connect at least one sensor device 470 (e.g., the first sensor device 471 or the second sensor device 473) in wireless communication. For example, the processor may connect the at least one sensor device over a third channel of the designated frequency band through a third communication module (e.g., the third communication module 403).

According to an embodiment, the second communication module and the third communication module each may support at least one communication protocol of Wi-F, Zigbee, Z-wave, UWB, BLE mech, or DECT. For example, the second communication module may support the Wi-Fi communication protocol, and the third communication module may support at least one communication protocol of Zigbee or Z-wave.

In operation 850, the processor may determine a data transmission and reception time of the at least one sensor device. Based on data transmission and reception information of the at least one sensor device, the processor may determine the data transmission and reception time of the at least one sensor device over the third channel. For example, the processor may calculate the time based on context information of the at least one sensor device stored in a memory (e.g., the memory 404). The context information may include, for example, at least one of activation/deactivation period (or wake-up/sleep period) information of the at least one sensor device, size information of a received command message (or control data), size information of a response message (or sensor data) for the command, period information for the state report or size information of a state report message (or data).

In operation 860, the processor may limit use of a channel overlapping (or adjacent to cause propagation interference) the communication channel of the at least one sensor device. If determining (or calculating) the time, the processor may determine whether the second channel and the third channel overlap, before the determined (or calculated) time arrives. In some embodiment, if the first channel is connected through the wireless communication, the processor may further determine whether the first channel and the third channel overlap.

According to an embodiment, if determining that the second channel and the third channel are overlapped (or adjacent), the processor may restrict other external device (e.g., the another AP and the at least one other station connected to the another AP) than the at least one sensor device from using a channel (an overlapping channel) overlapping (or adjacent to) the second channel and the third channel According to an embodiment, the processor may change the communication channel of the second communication module to the second channel, and transmit an RTS signal over the second channel through the second communication module. At this time, a destination of the RTS signal may be the electronic device, and the electronic device which is the destination of the RTS signal may transmit a CTS signal based on the RTS signal over the second channel According to an embodiment, the electronic device may generate and transmit a CTS signal without the RTS signal. For example, the electronic device may generate and transmit the CTS signal over the second channel by setting the destination of the CTS signal to the electronic device. Other external devices receiving the RTS signal or the CTS signal may limit data transmission for a designated time. Hence, the second channel including the overlapping channel may be clear. Next, the processor may change (or restore) the communication channel of the second communication module changed to the second channel, to the first channel before the change.

If the second channel partially overlapping (or adjacent to) the third channel is clear, the processor, which transmits and receives data to and from the at least one sensor device through the third communication module, may prevent data transmission and reception delay and collision.

According to an embodiment, if determining that the first channel and the third channel are overlapped (or adjacent), the processor may restrict other external device (e.g., the another AP, the electronic device and the at least one station connected to the electronic device) than the at least one sensor device from using a channel (an overlapping channel) overlapping (or adjacent to) the first channel and the third channel According to an embodiment, the processor may transmit an RTS signal over the first channel through the second communication module. At this time, a destination of the RTS signal may be the electronic device, and the electronic device which is the destination of the RTS signal may transmit a CTS signal based on the RTS signal over the first channel Other external devices receiving the RTS signal or the CTS signal may limit data transmission for a designated time. Hence, the first channel including the overlapping channel may be clear. In addition, if the first channel partially overlapping (or adjacent to) the third channel is clear, the processor, which transmits and receives data to and from the at least one sensor device through the third communication module, may prevent data transmission and reception delay and collision.

According to an embodiment, by temporarily resetting and transmitting a TIM field in a beacon message together with the RTS signal, the processor may notify no transmit packet to the other external device and thus control not to wake up the other external device from the sleep state (or the deactivation state).

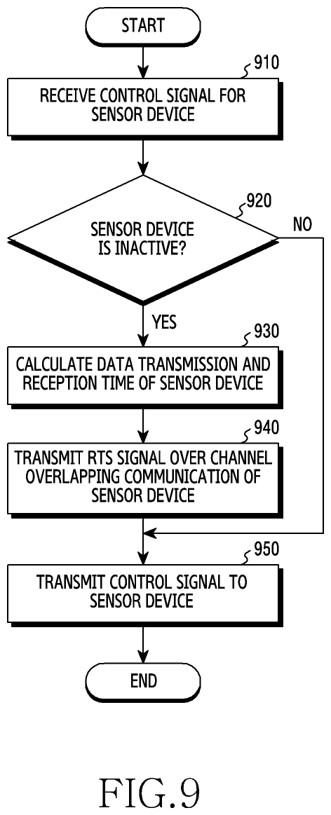

FIG. 9 is a diagram for illustrating a data transmission and reception method of an electronic device according to an embodiment of the disclosure.

Referring to FIG. 9, a processor (e.g., the processor 204, 305 or 405) of an electronic device (e.g., the sensor hub device 200 of FIGS. 2A and 2B, the sensor hub device 300 of FIGS. 3A and 3B or the sensor hub AP device 400 of FIGS. 4A and 4B) may receive a control signal for a sensor device (e.g., the sensor device 270, 370 or 470), in operation 910. For example, the processor may receive the control signal from a user device (e.g., the user device 210, 310 or 410) via the internet cloud and an AP (e.g., the AP 230 or 330).

In operation 920, the processor may determine whether the sensor device is inactive (or sleeping). If the sensor device is active (or in the wake-up state), the processor may transmit the control signal to the sensor device through a communication module (e.g., the second communication module 202 of FIG. 2B, the second communication module 302 of FIG. 3B or the third communication module 403 of FIG. 4B) communicatively connected with the sensor device, in operation 950. The sensor device in the active state is transmitting and receiving data or may transmit and receive data between the electronic device and the sensor device. For example, before receiving the control signal for transmitting to the sensor device, the processor may clear the communication channel of the sensor device by transmitting an RTS signal over an overlapping (or adjacent) channel of the communication channel of the sensor device. According to an embodiment, the electronic device may receive a control signal for the sensor device via the internet cloud and the AP during the data transmission and reception with the sensor device and transmit the control signal to the sensor device. According to an embodiment, the communication channel of the electronic device for transmitting and receiving the data to and from the sensor device and the communication channel of the electronic device for receiving the control signal for the sensor device via the internet cloud and the AP may not overlap.

If the sensor device is inactive (or sleeping), the processor may calculate a data transmission and reception time of the sensor device, in operation 930. For example, the processor may calculate the time based on context information of the sensor device stored in a memory (e.g., the memory 203, 304 or 404). The context information may include, for example, at least one of activation/deactivation period (or wake-up/sleep period) information of the sensor device, size information of a received command message (or control data), or size information of a response message (or sensor data) for the command.

In operation 940, the processor may transmit an RTS signal through a communication module (e.g., the first communication module 201 of FIG. 2B, the third communication module 303 of FIG. 3B or the second communication module 402 of FIG. 4B) which uses the overlapping (or adjacent) channel of the communication channel of the sensor device. Before the calculated time arrives, the processor may determine the channel (the overlapping channel) overlapping (or adjacent to) the communication channel of the sensor device among communication channels used by other external devices in a designated frequency band, and thus transmit an RTS signal over the overlapping channel through the communication module. In so doing, a destination of the RTS signal may be the electronic device, and the electronic device which is the destination of the RTS signal may transmit a CTS signal based on the RTS signal to the overlapping channel Other external devices receiving the RTS signal or the CTS signal may limit data transmission for a designated time. Hence, the communication channel overlapping (or adjacent to) the communication channel of the sensor device may be clear.

In operation 950, the processor may transmit the control signal to the sensor device through the communication module communicatively connected with the sensor device. If the communication channel overlapping (or adjacent to) the communication channel of the sensor device is clear, the processor which transmits and receives data to and from the sensor device, may prevent data transmission and reception delay and collision.

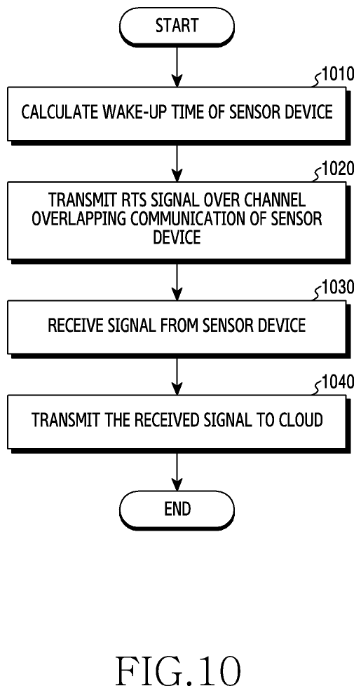

FIG. 10 is a diagram for illustrating another data transmission and reception method of an electronic device according to an embodiment of the disclosure.

Referring to FIG. 10, a processor (e.g., the processor 204, 305 or 405) of an electronic device (e.g., the sensor hub device 200 of FIGS. 2A and 2B, the sensor hub device 300 of FIGS. 3A and 3B or the sensor hub AP device 400 of FIGS. 4A and 4B) may calculate a wake-up (or activation) time of a sensor device (e.g., the sensor device 270, 370 or 470), in operation 1010. For example, the processor may calculate the time based on context information of the sensor device stored in a memory (e.g., the memory 203, 304 or 404). The context information may include, for example, at least one of state report period information of the sensor device or size information of a state report message.

In operation 1020, the processor may transmit an RTS signal through a communication module (e.g., the first communication module 201 of FIG. 2B, the third communication module 303 of FIG. 3B or the second communication module 402 of FIG. 4B) which uses the overlapping (or adjacent) channel of the communication channel of the sensor device. Before the calculated time arrives, the processor may determine the channel (the overlapping channel) overlapping (or adjacent to) the communication channel of the sensor device among communication channels used by other external devices in a designated frequency band, and thus transmit an RTS signal over the overlapping channel through the communication module. In so doing, a destination of the RTS signal may be the electronic device, and the electronic device which is the destination of the RTS signal may transmit a CTS signal based on the RTS signal over the overlapping channel Other external devices receiving the RTS signal or the CTS signal may limit data transmission for a designated time. Hence, the communication channel overlapping (or adjacent to) the communication channel of the sensor device may be clear.

The processor may determine whether there is an overlapping (or adjacent) channel of the communication channel of the sensor device, based on various methods. For example, the processor may determine the channel based on the communication module (e.g., the second communication module 202 of FIG. 2B, the second communication module 302 of FIG. 3B or the third communication module 403 of FIG. 4B) communicatively connected with the sensor device and the communication module (e.g., the first communication module 201 of FIG. 2B, the third communication module 303 of FIG. 3B or the second communication module 402 of FIG. 4B) which uses the overlapping (or adjacent) channel of the communication channel of the sensor device. For example, the processor may determine the overlapping (or adjacent) channel of the communication channel of the sensor device by monitoring on a periodic basis or for a designated time through the communication module (e.g., the first communication module 201 of FIG. 2B, the third communication module 303 of FIG. 3B or the second communication module 402 of FIG. 4B). For example, the processor may receive communication channel information used by the other device from the communication module (e.g., the first communication module 201 of FIG. 2B, the third communication module 303 of FIG. 3B or the second communication module 402 of FIG. 4B), and determine whether the received communication channel and the communication channel of the sensor device overlap at least in part or are adjacent (or affect each other). In various embodiments, determining the channel overlapping or the propagation interference at the processor may include determining (or identifying) whether there is an external electronic device (e.g., an AP, a station, a node or a device) transmitting a signal in the Wi-Fi channel overlapping the channel of the sensor device, and determining to affect the operation of the sensor device by causing interference to the channel of the sensor device. According to an embodiment, the processor may determine whether to transmit the RTS signal or the CTS signal based on the presence or absence of the external electronic device which may affect its operation by causing the interference to the channel of the sensor device. For example, if determining the absence of the external electronic device which may affect the operation by causing the interference to the channel of the sensor device, the processor may not transmit the RTS signal or the CTS signal.

In operation 1030, the processor may receive a signal from the sensor device through the communication module (e.g., the second communication module 202 of FIG. 2B, the second communication module 302 of FIG. 3B or the third communication module 403 of FIG. 4B) communicatively connected with the sensor device. If the communication channel overlapping (or adjacent to) the communication channel of the sensor device is clear, the processor which transmits and receives data to and from the sensor device may prevent data transmission and reception delay and collision. The signal may include, for example, a state report message of the sensor device.

In operation 1040, the processor may transmit the received signal to the cloud. For example, the processor may transmit the state report message received from the sensor device to the internet cloud. In addition, the processor may transmit a response message (e.g., an ACK signal) for the state report message to the sensor device. In so doing, the communication channel overlapping (or adjacent to) the communication channel of the sensor device may stay clear.

According to various embodiments of the disclosure, delay and collision in data transmission and reception of devices using a designated frequency band may be prevented.

In addition, according to various embodiments of the disclosure, by preventing delay and collision in data transmission and reception, battery consumption according to data transmission and reception retry may be reduced and device lifetime shortening may be prevented.

Besides, various effects directly or indirectly acquired in the disclosure may be provided.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first communication circuitry;
a second communication circuitry;
a processor operatively connected with the first communication circuitry and the second communication circuitry; and
a memory operatively connected with the processor,
wherein the processor is configured to:
connect a first external electronic device over a first channel of a designated frequency band through the first communication circuitry,
connect a second external electronic device over a second channel of the designated frequency band through the second communication circuitry,
determine a time when the second external electronic device transmits and receives data over the second channel, based on information on data transmission and reception of the second external electronic device,
determine whether the first channel and the second channel overlap in part or are adjacent, and
in response to determining that the first channel and the second channel overlap in part or are adjacent, transmit a signal requesting to limit use of the first channel over the first channel through the first communication circuitry, before the determined time arrives.

2. The electronic device of claim 1,
wherein the signal requesting to limit the use of the first channel comprises a request to send (RTS) signal, and
wherein the RTS signal comprises information of the determined time.

3. The electronic device of claim 2,
wherein the processor is further configured to transmit a clear to send (CTS) signal based on the RTS signal through the first communication circuitry, and
wherein the CTS signal comprises information of the determined time.

4. The electronic device of claim 1,
wherein the memory stores the information on data transmission and reception of the second external electronic device, and
wherein the information on data transmission and reception of the second external electronic device comprises at least one of activation/deactivation period information of the second external electronic device, size information of a command message transmitted to the second external electronic device, size information of a response message for the command message, period information for reporting state of the second external electronic device, or size information of a report message of the state of the second external electronic device.

5. The electronic device of claim 1,
wherein the designated frequency band comprises an industrial scientific medical (ISM) band, and
wherein the first communication circuitry and the second communication circuitry each support at least one communication protocol of Wi-Fi, Zigbee, Z-wave, ultra wide band (UWB), Bluetooth low energy (BLE) mesh, or digital enhanced cordless telecommunications (DECT).

6. An electronic device comprising:
a first communication circuitry;
a second communication circuitry;
a third communication circuitry;
a processor operatively connected with the first communication circuitry, the second communication circuitry and the third communication circuitry; and
a memory operatively connected with the processor,
wherein the processor is configured to:
connect a first external electronic device through the first communication circuitry,
obtain information of a first channel used by the first external electronic device in a designated frequency band,
connect a second external electronic device over a second channel of the designated frequency band through the second communication circuitry,
determine a time when the second external electronic device transmits and receives data over the second channel, based on information on data transmission and reception of the second external electronic device,
determine whether the first channel and the second channel overlap in part or are adjacent, and
in response to determining that the first channel and the second channel overlap in part or are adjacent, transmit a signal requesting to limit use of the first channel over the first channel through the third communication circuitry, before the determined time arrives.

7. The electronic device of claim 6,
wherein the processor connects the first external electronic device in wireless communication through the first communication circuitry, and
wherein a frequency band used to connect the first external electronic device is different from a frequency band used by the first external electronic device to connect other external electronic device.

8. The electronic device of claim 6,
wherein the signal requesting to limit the use of the first channel comprises a request to send (RTS) signal, and
wherein the RTS signal comprises information of the determined time.

9. The electronic device of claim 8,
wherein the processor is further configured to transmit a clear to send (CTS) signal based on the RTS signal through the third communication circuitry, and
wherein the CTS signal comprises information of the determined time.

10. The electronic device of claim 6,
wherein the memory stores the information on data transmission and reception of the second external electronic device, and
wherein the information on data transmission and reception of the second external electronic device comprises at least one of activation/deactivation period information of the second external electronic device, size information of a command message transmitted to the second external electronic device, size information of a response message for the command message, period information for reporting state of the second external electronic device, or size information of a report message of the state of the second external electronic device.

11. The electronic device of claim 6,
wherein the designated frequency band comprises an industrial scientific medical (ISM) band, and
wherein the second communication circuitry and the third communication circuitry each support at least one communication protocol of Wi-Fi, Zigbee, Z-wave, ultra wide band (UWB), Bluetooth low energy (BLE) mesh, or digital enhanced cordless telecommunications (DECT).

12. An electronic device comprising:
a first communication circuitry;
a second communication circuitry;
a third communication circuitry;
a processor operatively connected with the first communication circuitry, the second communication circuitry and the third communication circuitry; and
a memory operatively connected with the processor,
wherein the processor is configured to:
connect an external server through the first communication circuitry,
connect a first external electronic device over a first channel of a designated frequency band through the second communication circuitry,
obtain information of a second channel used by the first external electronic device in the designated frequency band,
connect a second external electronic device over a third channel of the designated frequency band through the third communication circuitry,
determine a time when the second external electronic device transmits and receives data over the third channel, based on information on data transmission and reception of the second external electronic device,
determine whether the second channel and the third channel overlap in part or are adjacent, and
in response to determining that the second channel and the third channel overlap in part or are adjacent, transmit a signal requesting to limit use of the second channel over the second channel through the second communication circuitry, before the determined time arrives.

13. The electronic device of claim 12,
wherein the processor is further configured to:
change a communication channel of the second communication circuitry to the second channel, and
transmit a request to send (RTS) signal over the second channel, and
wherein the RTS signal comprises information of the determined time.

14. The electronic device of claim 13,
wherein the processor is further configured to transmit a clear to send (CTS) signal based on the RTS signal through the second communication circuitry, and
wherein the CTS signal comprises information of the determined time.

15. The electronic device of claim 13, wherein the processor is further configured to restore the communication channel of the second communication circuitry to the first channel.

16. The electronic device of claim 13, wherein the processor is further configured to:
reset a traffic indication map (TIM) field in a beacon message, and
transmit the beacon message together with the RTS signal.

17. The electronic device of claim 12, wherein the processor is further configured to:
determine whether the first channel and the third channel overlap in part or are adjacent, and
in response to determining that the first channel and the third channel overlap in part or are adjacent, transmit a signal requesting to limit use of the first channel over the first channel through the second communication circuitry, before the determined time arrives.

18. The electronic device of claim 17, wherein the signal requesting to limit the use of the first channel comprises at least one of an RTS signal or a CTS signal.

19. The electronic device of claim 12,
wherein the memory stores the information on data transmission and reception of the second external electronic device, and
wherein the information on data transmission and reception of the second external electronic device comprises at least one of activation/deactivation period information of the second external electronic device, size information of a command message transmitted to the second external electronic device, size information of a response message for the command message, period information for reporting state of the second external electronic device, or size information of a report message of the state of the second external electronic device.

20. The electronic device of claim 12,
wherein the designated frequency band comprises an industrial scientific medical (ISM) band, and
wherein the second communication circuitry and the third communication circuitry each support at least one communication protocol of Wi-Fi, Zigbee, Z-wave, ultra wide band (UWB), Bluetooth low energy (BLE) mesh, or digital enhanced cordless telecommunications (DECT).
